(19) United States
(12) Patent Application Publication
(10) Pub. No.: US 2014/0032288 A1
(43) Pub. Date: Jan. 30, 2014

(54) Method For Facilitating Decision-Making Related To Goal Attainment

(71) Applicant: Jonathan M Rosenberg, Boca Raton, FL (US)

(72) Inventor: Jonathan M Rosenberg, Boca Raton, FL (US)

(21) Appl. No.: 13/917,206

(22) Filed: Jun. 13, 2013

Related U.S. Application Data
(60) Provisional application No. 61/659,283, filed on Jun. 13, 2012.

(51) Int. Cl. H04L 12/58

(52) U.S. Cl. CPC H04L 51/32
USPC 705/14.11; 709/204

(57) ABSTRACT

The invention relates to a method for facilitating decision-making related to goal attainment, the steps of the method including providing a pool of prospective category-specific advisors, each of which have joined a membership community; selecting from the pool of category specific advisors, a subset thereof sufficient to define an online forum qualified for consideration of a given goal-related question; and then syntactically refining the goal-oriented question expressed by a system user by resolving the question into components, the refining step including (i) reviewing for and providing accuracy of forum of the components by a language processing agent of the system; and (ii) reviewing for accuracy of substantive meaning by the system user of the goal oriented question components. The method further comprises the step of providing the refined question components to the forum for consideration; and then providing from the forum to the system user respective answers or opinions of the forum in response to the goal oriented question and components of it.

### CROSS REFERENCE TO RELATED APPLICATION

This application claims the benefit under 35 USC 119(e) of the provisional patent application Ser. No. 61/659,283, filed Jun. 13, 2012, which is hereby incorporated by reference in its entirety.

### FIELD OF INVENTION

This invention relates to a method for the provision to a system user of a forum of social media, for guidance with respect to goal-related issues with which the system user may be concerned.

### BACKGROUND OF THE INVENTION

Software, since it was developed for use with personal computers in the 1990s, has for the most part addressed the improvements and uses of new hardware and its or applications. However, in general, software has rarely addressed problems of a human, personal or physiological character.

The first appearance, known to within inventor of such software, occurred within business environments in which the objective was to enhance the efficiency of an employee or individual within an organization such that goals dictated by the business organization or management thereof could be more efficiently accomplished. An example of such software appears in U.S. Pat. No. 5,369,732 (1994) to Lynch et al, entitled Method and Apparatus For Goal Processing Memory Management.

Other related software, known to the applicant, is concerned primarily with the assisting of project managers within a business to accomplish their goals, this as is reflected in U.S. Pat. No. 7,774,220 (2010) to Sullivan et al, entitled Project Management System For Aiding Users In Attaining Goals.

Only recently have personal assistants or so-called personal coach software of any kind appeared, an example thereof being U.S. Patent Application Publication US2008/0082465 (2008) to Meijer et al, entitled “Guardian Angel,” held by the Microsoft Corporation. This invention amounts to a “robotic life advisor,” the object thereof being to enable the “guardian angel” and its supporting hardware to function as a protector and assistant in substantially every area of decision-making of human concern or enterprise.

A related but more goal-specific adaptation of the Microsoft Guardian Angel appears in U.S. Pat. No. 7,827,050 (2010) to Bangel et al, entitled Comprehensive Goal Management With The Use of Integrated Software Application, held by the IBM corporation. Such software as is reflected in Meijer and Bangel are too complicated and, for most users, too costly for use in a social media context or related application. As such, the prior art, as set forth above, is indicative that certain software, in combination with appropriate hardware can provide interesting and helpful goal-related suggestions to users thereof but none exist in systems having ongoing interaction with persons or groups thereof (hereinafter “forums”) who have been recruited in a social media context and in which they have volunteered to participate to assist parties seeking assistance to facilitate decisions relative to specific goals in life regardless of how important or unimportant such goals may be from a larger perspective of society or business.

The present invention therefore seeks to adapt the capability of social media to several of the goal processing and management issues previously addressed strictly through software and its supporting hardware, but mainly for business purposes.

### SUMMARY OF THE INVENTION

The invention relates to a method for facilitating decision-making related to goal attainment, the steps of the method comprising providing a pool of prospective category-specific advisors, each of which have joined a membership community; selecting from said pool of category specific advisors, a subset thereof sufficient to define an online forum qualified for consideration of a given goal-related question; and then syntactically refining the goal-oriented question expressed by a system user by resolving said question into components, said refining step including (i) reviewing for and providing accuracy of forum of said components by a language processing agent of said system; and (ii) reviewing for accuracy of substantive meaning by the system user of said goal oriented question components. The method further comprises the step of providing said refined question components to said forum for consideration thereby; and then providing from said forum to the system user respective answers or opinions of the forum in response to said goal oriented question and components thereof.

It is accordingly an object of the present invention to provide a method by which selectable, qualified sub-groups of a social media membership community may render assistant to community members having a need therefore for in the making of decisions related to personal goal attainment and in the formulation of steps by which such goals may be attained.

It is another object to provide a method and system of the above type in which participants at all aspects thereof, inclusive of the individual requesting decision-making assistance, members acting upon a specific goal-attainment related inquiry, and parties, providing a system oversight to the interaction occurring between anonymous forums and users requesting assistance, all receive promotional credits of varying types which credits may be expressed a various merchant benefits through the membership community and its merchant members.

### BRIEF DESCRIPTION OF THE DRAWINGS

FIGS. 1 and 2 are generic flow diagrams showing the Merlin application at a conceptual level.

FIG. 3 is a flow diagram concerning the procedure for resolving user goal oriented questions into constituent components and sub-components.

FIG. 4 is a flow diagram, connection to diagram of FIG. 3 at node B, showing further steps in the process of parsing or refining a goal-oriented question of the system user.

FIG. 5 is a flow diagram, further to that of FIGS. 3 and 4 in which nodes C, E, F, G and I thereof connect to corresponding nodes of FIG. 4.

FIG. 6 is a flow diagram view showing the timing of action steps in which node A thereof relates to node A of FIG. 3, node D thereof relates to node D of FIG. 4 and node J thereof relates to node J of FIG. 5.

FIG. 7 is a flow diagram view of a further portion of the present invention showing further steps in the question parsing process and showing user evaluation process.

FIG. 8 is a further diagrammatic view relating mainly to the interaction between a system user and a forum member.

FIG. 9 is a further diagrammatic view addressing largely the function of a category-specific anonymous forum in which nodes L, M, N and Q thereof relate to nodes L, M, N and Q of FIG. 8.

FIG. 10 is a further flow diagrammatic view of the present system in which node R thereof relates to node R of FIG. 3, nodes K and T thereof relate to nodes K and T of FIG. 8.

### DETAILED DESCRIPTION OF THE INVENTION

The present system and method provides a means for helping people break down their goals into subparts while providing anonymous advice in the event the person is unsure of how to pursue a goal.

The disclosed software helps a user resolve one's goals into subparts and then each subpart is resolved into further subparts. If, at any time the user is unsure of what to do, the software will prompt the user to ask for advice anonymously from a network of people who are themselves anonymous or the user may ask for help from a network of life coaches. This process continues until each subpart of the goal cannot be resolved any further. The software, at each subpart, asks the user to make at least three appointed times, one is for when they wish to take action toward a goal, another is for when the software is to ask the user how things went. The other time is when the user wishes to be reminded prior or at the time of when the component takes place. When the appointed time for action arrives, the system will notify the user of the appointment. The software will then ask the user if he/she succeeded at accomplishing that subpart. If the subpart did not act as planned, the software will then offer to reschedule, edit the subpart, or anonymously ask for advice from a network of people who are anonymous as well, or the user may ask for help from a network of life coaches.

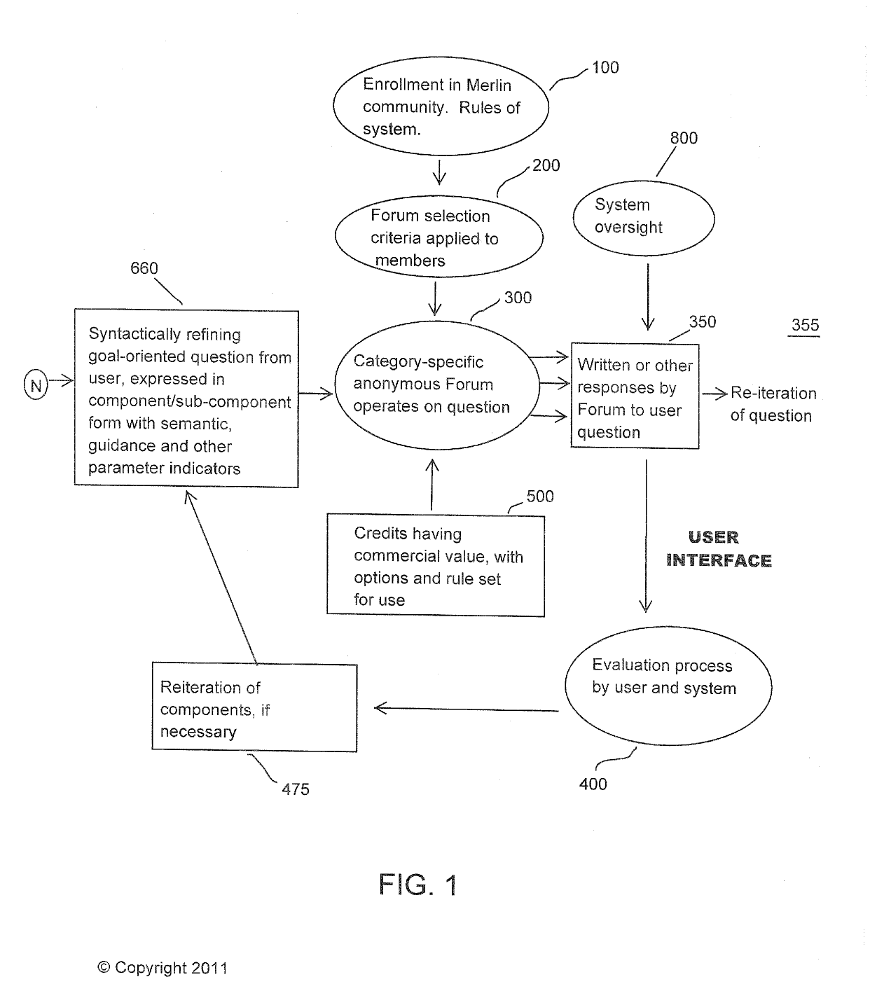

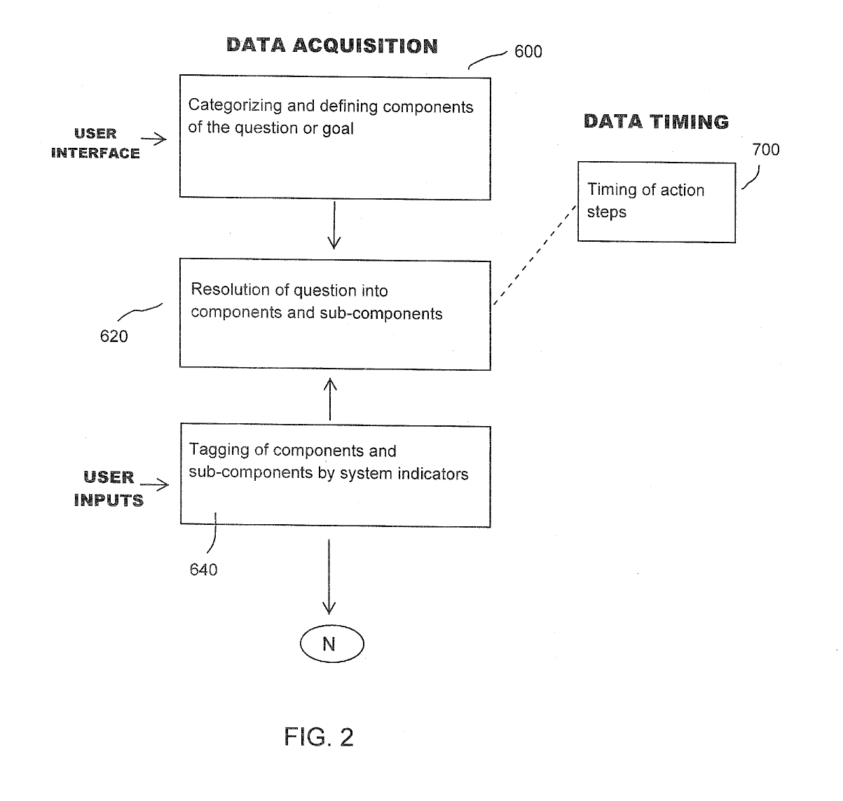

With reference to FIGS. 1 and 2, the generic concept of the goal resolution system may be appreciated. More particularly, in FIG. 1, the enrollment process is shown at step 100, while forum selection criteria as applied to community members is shown at step 200. Ultimately, after an appropriate procedure, as below described, a category-specific question or issue of concern to the system user is defined. This is shown at step 300. Providing of the goal-related question or issue of the system user is a central aspect of the present invention and, with respect to FIG. 2, may be seen to include a user interface which categorizes into components the question or goal shown in block 600. Therefrom, the initially expressed question or goal is resolved into components and, where appropriate, sub-components, as is shown at block 620. An artificial intelligence (“AI”) of the present system, shown at block 640, provides for the tagging of components and sub-components of the system, more fully described below, by particular system indicators in order, inter alia, that a particular question may be assigned to a forum having an interest or qualifications relevant to the question asked.

The timeline of the question resolution process is shown generically in FIG. 2 at block 700, and is more fully described below. Connection node N of FIG. 2 relates to connection node N of FIG. 1 indicating that after the tagging of components and sub-components by system indicators has occurred the result, shown in block 660 is that of a syntactically refined goal-oriented question from the user, expressed in component/sub-component form which includes semantic, guidance and other parameter indicators furnished thereto as a result of the function in block 640. The question of the system user, when so refined, is then fed into a category-specific anonymous forum 300 which operates upon the question which has been resolved. This is shown as element 300 in FIG. 1.

A sample of categories which may be selected by a system user or the AI 640 of the system constitute choices for components or sub-goals including:
Location/Venue
Money/Investment
Transportation
Homework/Practice
Education/Research
Speech/Presentation
Perform/Sing/Act
Obtain or Give Resources
Recruit/Enroll/Hire
Communicate
Find Employment
Build/Create
Advertise/Market
Entertainment/Fitness
Clean/Prepare
Go Shopping

The user to find help anonymously

The user may choose to enter a component manually. The ability to ask for help is available later, as is below described.

The anonymous forum which becomes assigned to a question of the system user results in written or other responses by the forum to user questions, this shown at block 350. If necessary, the question may be reiterated, as shown at 355 of FIG. 1, such that the forum may provide a second round of responses to the system user. Steps 350 and/or 355 lead to a user evaluation process indicated by step 400 in FIG. 1 which, as may be necessary, may result in a reiteration 475 of the entire process in which case the question will again be syntactically refined at step 660 as above set forth.

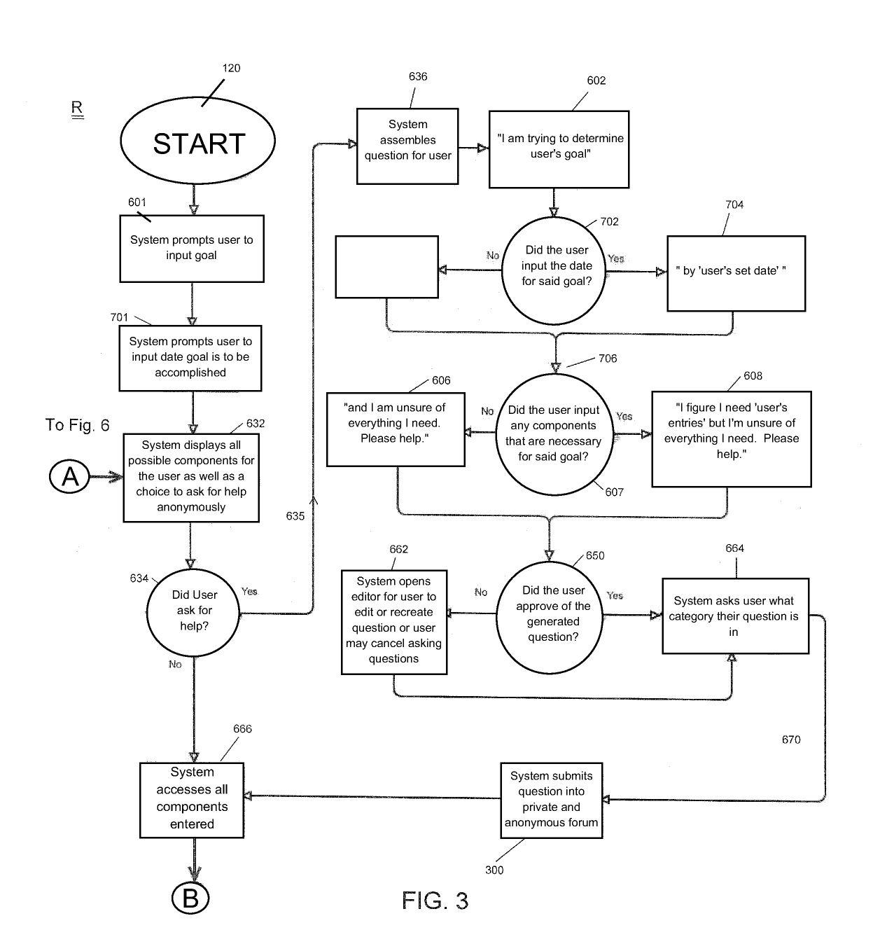

The conceptual or expression of the invention as set forth in FIGS. 1-2 may be more fully appreciated with respect to the detailed programming set forth in FIGS. 3-10 below. More particularly, with reference to FIG. 3, there is shown a more detailed treatment of steps 600, 620, 640 and 660 above. Therein, at step 602, the system attempts to determine the user's goal, while at steps 702 attempting to determine the timeframe which is associated with such goal. Timing is further refined at step 704 of FIG. 3 after which at point 706 all date-related questions has been resolved. The system, at decision diamond 604 determines whether the user has input any components that are necessary for the expression of the goal. If he has not, the program proceeds to steps 606 in which the user may ask for help. If the user has input some components but not all necessary for a forum needed to consider the user's goal, the program proceeds to step 608. Ultimately, the system user must approve the question generated, this as indicated at decision diamond 650. If further refinement of the question, in the opinion of the user, is necessary, the system proceeds to block 662 which permits the AI editor to re-create the question in a fashion that may be more acceptable to the user. To be certain that the question is properly categorized, and proper forum matching as above described is accomplished, the system ask the user his opinion as to what category, as shown on a provided drop down list of categories, the question should be in. This is shown in block 664 in FIG. 3. Therefrom, the system proceeds along line 670 and to submission of the question, as now properly parsed as to form and category, into the categories of a specific anonymous forum indicated in step 300 in FIGS. 1 and 3.

At step 666, the system accesses all components entered and a final review of the question occurs.

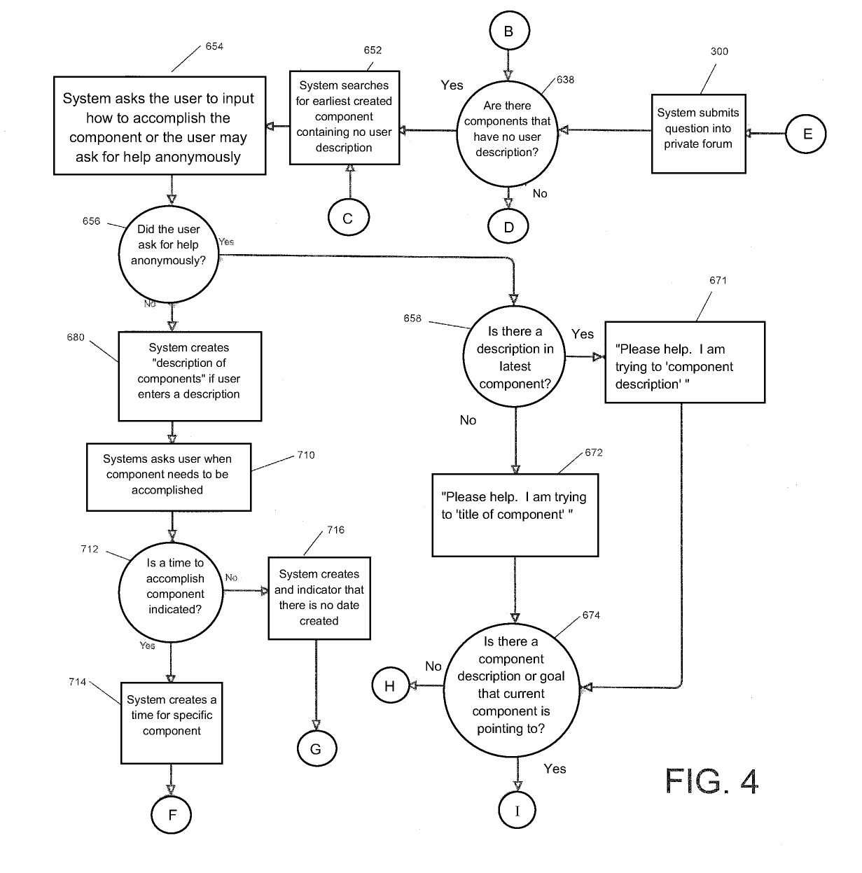

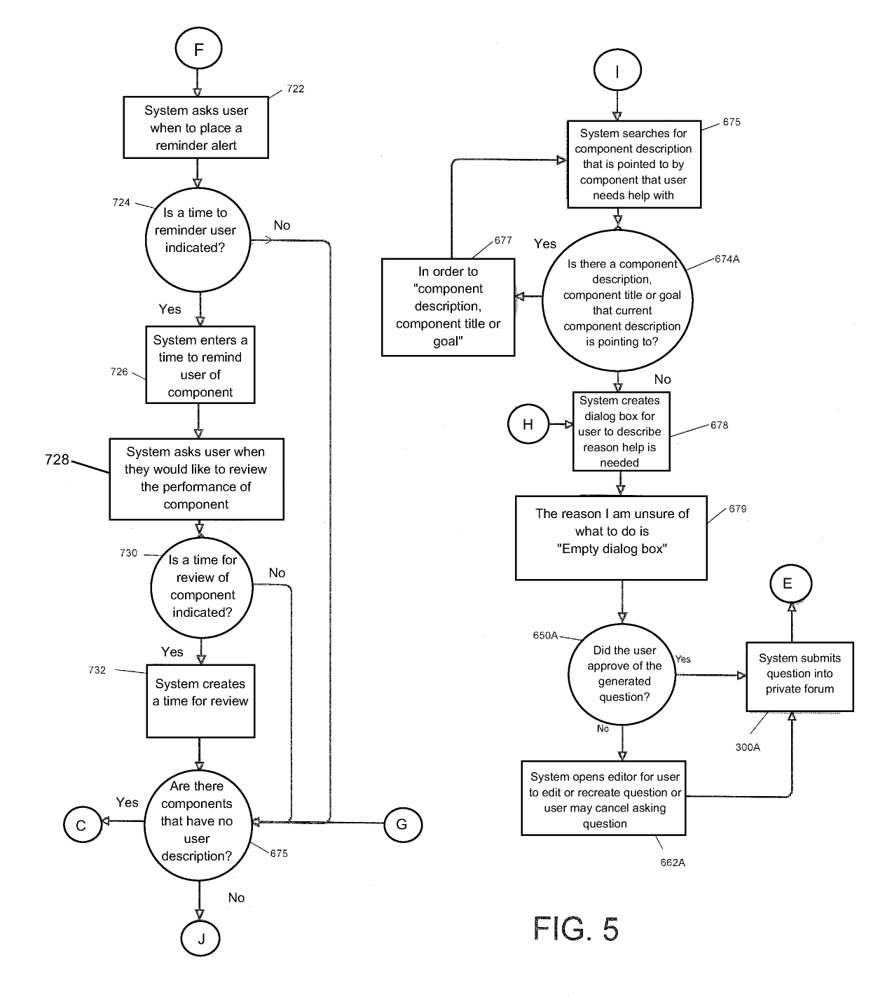

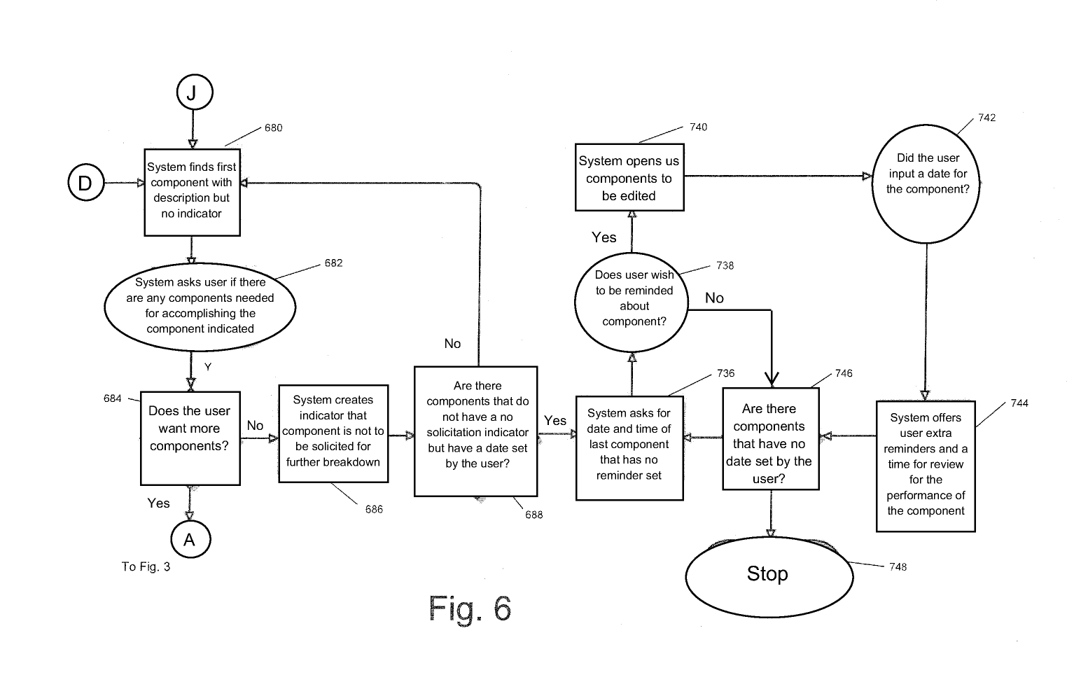

As may be noted to the left of FIG. 3, after the system begins at start 120, the system prompts the user to input a goal of interest, shown as step 601. Thereafter, in step 701, the system prompts the user to input a date at which he wishes to have accomplished his stated goal so that he can eventually become a part of the decision diamond 702, above described. Step 701 is followed by a display 632 to the system user of all possible components having potential relevancy to the question asked. This assists the AI of the system, as shown generally in step 660 of FIG. 1. To resolve the question or goal into all components which it can discern within the question as asked. If more components are wanted, node A of FIG. 3 connects to node A of FIG. 6 where further question resolution occurs. The user may also request help anonymously. That is, proceeding to diamond 634 in FIG. 3, the system determines if the user has asked for help. If such is the case, line 635 is followed upon which the system assembles the question for the user, this as shown at block 636. However, if the user does not ask for assistance at diamond 634, the program proceeds to access all entered components as shown at block 666. Thereupon the system proceeds to node B (see FIG. 4) and diamond 638, that is, “Are there other components that have no user description?” If the answer is “yes,” the system proceeds to block 652. Therein, the system searches for the earliest created components containing no user description. Thereupon, at function 654, the system asks the user to input the best manner to resolve the component or, alternatively, the user may ask for help anonymously. This is monitored at diamond 656. If the user did ask for help anonymously, the system proceeds to decision diamond 658, asking “Is there a descriptor in the last component of record?” If the answer to this question is “yes,” the system proceeds to step 671 in which the user asks for help indicating to the system that he is attempting to establish a component description. However, if there is a requisite description, at decision 658, of the pending component description, the system proceeds to step 672 of FIG. 4 in which the user request help in determining a proper title of the component he is considering. This step will lead to decision diamond 674, related to the above-described block 660 of FIG. 1, and asks “Is there a component description or goal that the current component is pointing to?” In this program, the terms “pointing” and “indicator” are used interchangeably. If the answer to the question of diamond 674 is “yes,” the system proceeds to node I (see FIG. 5) and proceeds to block 675 wherein the system searches for a component description that is pointed to or indicated by that component with which the user needs help.

This process leads to decision diamond 674A in which the system asks “Is there a component description, component title or goal that the current component description is pointing to?” If the answer thereto is “yes,” the system proceeds to the left as shown in FIG. 5 in order to establish a component description, component title or goal description, as is shown at 677. If however is the answer to the question of diamond 674A is in the negative, the system proceeds to block 678 at which the system then creates a dialog box for the user and, therein, he will describe the reason that help, in his opinion, is needed at that point in the program. An example of a reason why a user might need help is shown at step 679 of FIG. 5. This will lead the user to decision diamond 650a, similar to decision diamond 650A, above described with respect to FIG. 3, which asks if the user approves of the generated question. If the answer is “yes,” the system submits the question into a private forum 300A, in analogous fashion to submission into the anonymous forum 300 above-described in FIG. 3. However, if the answer to the question at decision diamond 650A is in the negative, the system proceeds to step 662A, analogous to step 662 of FIG. 3, in which the system opens its syntax editor to enable the user to edit or to recreate a question or to cancel a pending question.

Further to FIG. 4, following decision diamond 656, if the answer to the question of diamond 656 is in the negative, the program proceeds to block 680 at which the system creates a description of the component if the user has entered the description. Thereafter, at step 710, the system asks the user when in the timeline (see block 700 of FIG. 2) a component of a question needs to be resolved. In other words, the system provides the possibility that not all components of a given question or goal would need to be resolved simultaneously.

The system then proceeds to decision diamond 712 which asks whether the time for the accomplishment for each component of the system has been indicated. If the answer thereto is “yes,” the system then proceeds to block 714 and indicates a time-specific signature for the corresponding component. However, if the answer to decision diamond 712 is negative, the system proceeds to block 716 at which the system provides an indicator that no date has been provided for the indicator component. Therefrom the system proceeds to node G which in turn leads to diamond 675 (see FIG. 5) which asks “Are there components which that have no user description?” This question, (shown at the left of FIG. 5) is the end result of a series of steps which begin at block 714 at the lower left of FIG. 4, that is, connection node F in which the system asks the user when to place the reminder alert, this shown as step 722 of FIG. 5. From such step, the system leads into diamond 724 which asks “Is there a time at which the user should be reminded with respect to some aspect of a component necessary to his question or goal?” If the response thereto is in the negative, the program proceeds downward along line 725 and into decision diamond 675 as above described. However, if the response to diamond 724 is in the positive, the system will enter the indicated time at which the user should be reminded with respect to an issue relative to a component of the question which is asked. This is indicated as block 726. Therefrom, at block 728, the system asks the user when he would like to review his performance or progress in regard to selection of a given component of a given question. Thereafter, the question at diamond 730 asks if a given time to review a given component is indicated. If the answer thereto is in the negative, the program proceeds to diamond 675 above-described. However, if the answer thereto is in the affirmative, the system proceeds to block 732 at which the system arbitrarily creates a time at which a component review is to occur.

Diamond 675 asks, “Are there components that have no use or user description?” If affirmative, the program will proceed to connection mode C or if negative, to connection mode J. Connection mode C is shown in FIG. 4 and below block 652 above described, whereas connection node J is then shown at the upper left of FIG. 6 and, as in the case of connection node D shown at the top of FIG. 4, feeds into block 680 in which the system finds a first component having a descriptor but lacking an indicator or pointer. The system, following block 680, then at 682 proceeds to ask, if there exists any components that are needed to resolve a component or sub-component indicated at that time. If the user, at decision diamond 684 indicates that he wishes to consider more components in the parsing of his question of goal description, the system will then lead either to connection node A, also shown at the left of FIG. 3, or if the response is in the negative, the system, at block 686 creates an indicator that a given component is not to be addressed for any further degree or parsing. This in turn leads to decision diamonds 688 which asks is there are components that do not have a solicitation indicator for further breakdown but have not date set by the user. If the response thereto is in the affirmative, the program returns to step 680, shown in FIG. 6. If the response to decision diamond 688 is in the negative, the system proceeds to block 736 in which the system asks for a date and time for a first component within a last set of components that is lacking in a date indicated by the user. Therefrom the program proceeds upward to decision diamond 738 which asks the user if he wishes to schedule when to work further on a component of his question. When the user is ready to work on such component, the system, as indicated at block 740, opens up, that is, provides a means of options for editing of the pending components. The system then, at decision diamond 742 asks if the user inputted a date to be associated with the component at issue. At block 744, the system may offer the user extra reminders and time for the review of performance of a component within the larger context of the goal-oriented question of interest. Finally, in terms of the time sequencing of the task shown in block 660 of FIG. 1 of syntactically refining the goal-oriented question of the user, the system, asks, at diamond 746 if a date for resolution of all components has been established by the user. If the answer is no, this part of the program stops as is indicated at 748 in FIG. 6.

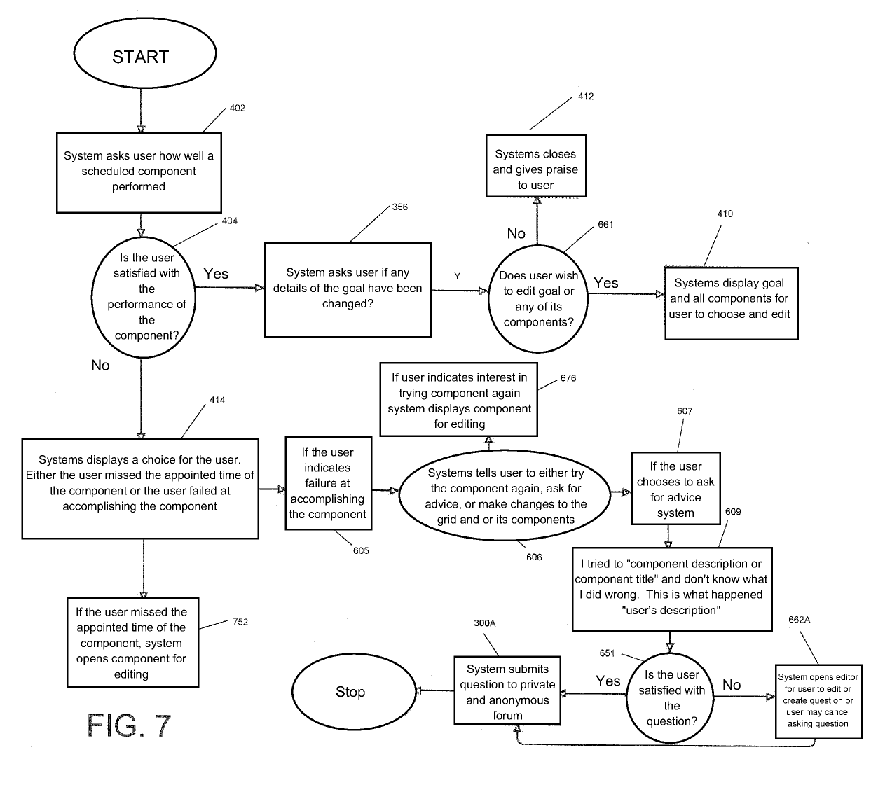

With reference to FIG. 7, there is shown a user retrospective routine within the inventive system which enables the user to review and, as necessary, modify inputs response to the system above described. More particularly, following the start symbol shown a the left of FIG. 7, the system at step 402 asks the user how well a scheduled component of his goal-oriented question has performed during the forum process. Thereafter, at diamond 404, the system asks the user if he is satisfied with the performance of that component. If the response is in the affirmative, the program proceeds to step 356 wherein the system asks if any details of the goal have been changed, which in turn leads to the questions of diamond 661, namely, “Does the user wish to edit his goal or any other of the components?” If he does wish to do so the system, block 410 will then display the existing goal and all components thereof in which the user may choose to modify or edit the same. If however the response to question 661 is in the negative, the system, at step 412 will close and provide praise or congratulations to the user upon successful completion of the question de-composition process.

Returning to the left hand side of the routine of FIG. 7, if the response of a user to question 404 is in the negative, the program will proceed will proceed to step 414 at which the system displays a choice for the user. For example, either the user will have missed an appointed time regarding comment about a component or the user may have failed at accomplishing or identifying a particular component. Therefrom, if the user does not indicate such failure, he will proceed to block 752 indicating that the user simply missed an appointment time with respect to comment upon a component and thereupon is permitted to open the component of the question for further editing (block 662 and 662A described above). If however, the user, following a failure in accomplishing resolution of a component (step 605), the system proceeds to step 606 in which the system tells the user to either try the component again, request advice or make changes to the goal and/or to components thereof which have presented an issue for the user. If the user wishes to further try to correct problem, he proceeds to block 676 wherein the user will indicate an interest in trying again to identify a suitable component and the system will assist in displaying such component for potential editing.

Alternatively, following step 606, the user may ask the system for advice, as is indicated at block 607. If such advice is sought, the user proceeds to step 609 in which he will indicate the issue, by typing into a dialog box, remarks to the effect of “I tried a component description or component title and don't know what I did wrong. This is what happened,” which would be followed by the user's description of the problem as he understands it. This step, possibly with the help of a system administrator, is followed by decision diamond 651 which then asks if the user is satisfied with the question as reconfigured. If the response is in the negative, the system proceeds to block 662A. See also block 662 in FIG. 3) in which the system will open an editor for the user to edit or recreate a question or for the user to cancel a pending question. From there, the system will proceed to block 300A if the user is able to recreate the question. Similarly, if the response to decision diamond 651 is in the affirmative, the system will also proceed to block 300A in which the system submits the question to the private and anonymous forum (see also block 300 in FIG. 4 and block 300A in FIG. 5). At that point, the anonymous forum 300 (see FIG. 1 and FIG. 4) will begin to function.

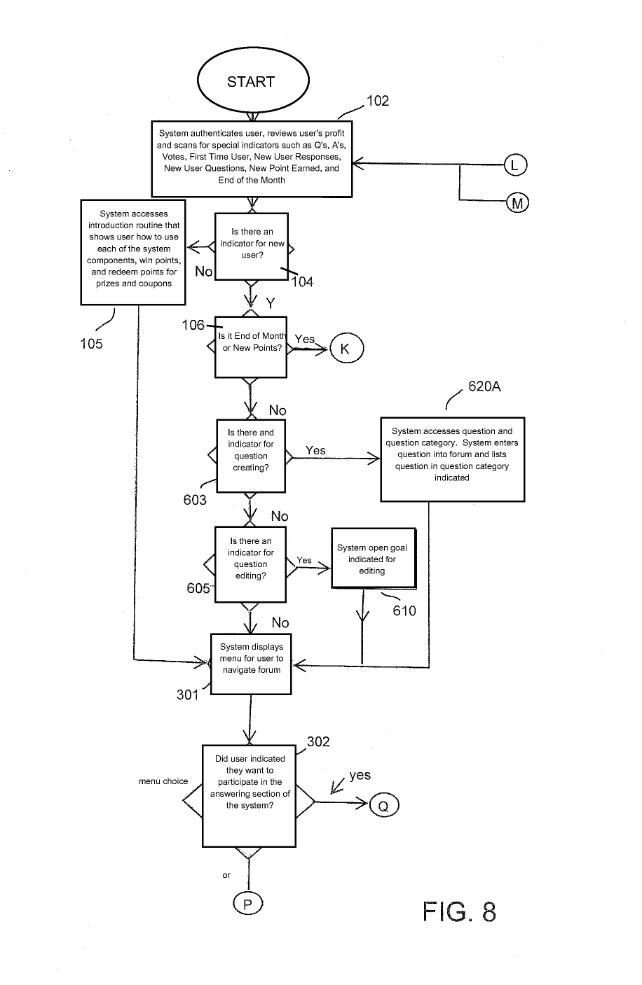

A further perspective of the present inventive system for providing a system responsive to a goal-oriented question is shown in FIGS. 8-10. More particularly, in FIG. 8 is shown the start function upon which the user sees screens 102. Therein the system authenticates the user, reviews the user's profile and scans for special indicators which may be applicable to the user, including particular questions and answers which may help to categorize a question for initial parsing (per block 600 of FIG. 2) and explains rules relative to voting, first time user information, new user's response and guidance, new user's sample or actual questions, methods by which points are earned, and timeframes in which credits are furnished to the user, (typically on a monthly basis). From introductory screens 102, the system proceeds to decision diamond 104 asking if there exists a particular indicator for the new user. If the user's response is in the negative, the system will proceed to screen 105 which enables the new user to access an introduction routine which shows the user how to employ each of the system components, win points, redeem points for prizes or coupons, and other more detailed information not encompassed within screens 102.

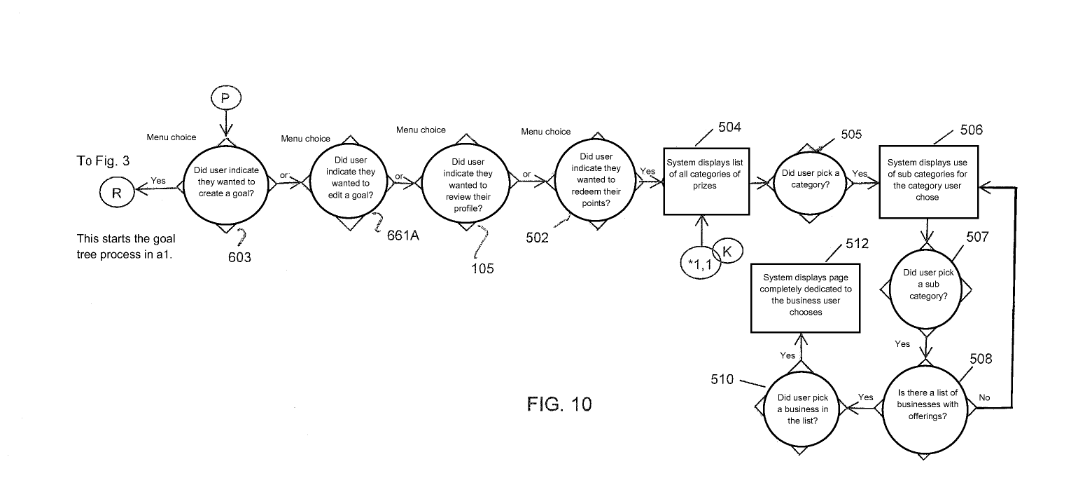

Returning to decision diamond 104, if a response thereto is in the affirmative, the system proceeds to decision diamond 106 asking whether it is the end of the month or are there new points to be awarded? If the answer thereto is yes, the system proceeds to connection node K of FIG. 10, described below.

If however the response to decision diamond 106 is in the negative, the program proceeds to decision diamond 603 in which there is asked the question “Is there an indicator for question creating?” If the response thereto is in the affirmative, the system proceeds to block 620A (see also block 620 in FIG. 2) in which the system accesses question and question categories and the system enters the question into the forum and lists questions in the question category which have been indicated by the function of steps 620, 640, and 660 of FIGS. 1 and 2 in addition to those more specific questions parsed steps in the above discussed with respect to FIGS. 3-5. Following step 620A, the system will proceed to step 301 in which the system provides to the user a menu to assist in his navigation of the forum.

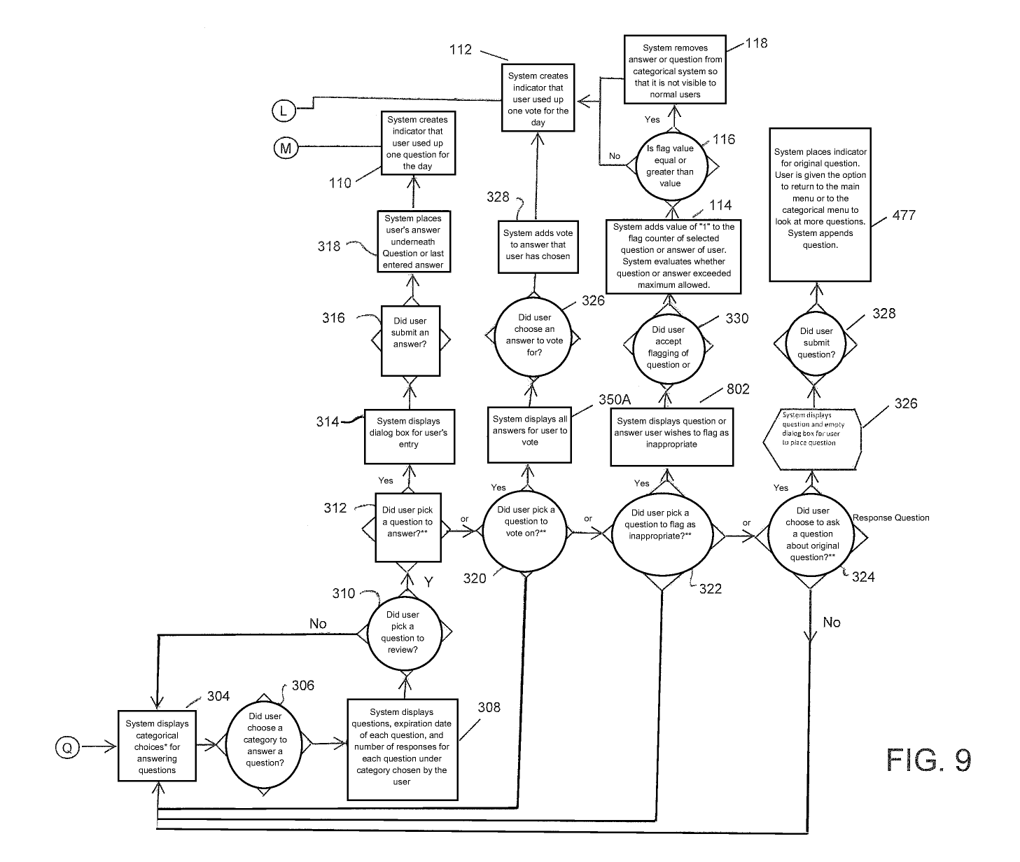

If the user's response to decision diamond 603 is in the negative, the system proceeds to decision diamond 605 which asks “Is there an indicator for the pending question requiring editing?” If the response thereto is in the affirmative, the system proceeds to step 610 by which the system then opens a display for purposes of goal editing before submission to a forum. However, if the response to decision diamond 605 is in the negative, the user is then brought to the display menu 301 for navigation of the forum, as above described. Following these steps, the user proceeds to decision diamond 302 which is a menu choice in which a prospective forum member is asked to indicate whether he wishes to participate in a given forum. If the party's response is in the affirmative, the program proceeds to connection node Q and therefrom into the routine of the program shown in FIG. 9. That is, connection node Q brings the user to step 304 in which the system describes the category choices to the forum member and the question posed by a system user. Therefrom the system will proceed to decision diamond 306 in which the forum participant is asked to chose a category within which to answer the question, given that ambiguity may exist as to which category a given question of a user may fall into. Thereafter the system proceeds to step 308 in which the system displays question, expiration date of a given question, and number of responses for each question under the category chosen by the user. From there the system proceeds to decision diamond 310 in which a prospective forum member is asked whether he has picked a question to review. If the response is in the negative, the system returns to step 304 and the loop 306/308/310 is repeated.

Proceeding from decision diamond 310, the system will then ask whether prospective forum member selected a question to answer. Therein, the system also evaluates whether a prospective forum member has exhausted his answer or voting privileges. There will exist a limit as to how many questions and answers are available per day to a system user and forum member. The inventor contemplates the number of questions per day will be three and the amount of answers per day will, as well, be three. The amount of votes permitted, which relate to the degree of satisfaction of the system participants, is limited to seven per day.

It is noted that if a user flags a question or answer as inappropriate (see block 800 in FIG. 1) that is counted as a vote. However, there exists an unlimited number of response questions. Users who ask the original question are rewarded for their response to a response question in the forum (see step 355 in FIG. 1 and 324 in FIG. 9).

Proceeding from decision diamond 312, the user continues to step 314 in which the system displays a dialog box for the user's entry, this corresponding to responsive block 350 in FIG. 1. Therefrom, at decision diamond 316, the system asks whether a forum member submitted an answer. If so, at block 318, the system places the user's answer underneath the question or underneath the last entered answer. Thereafter, at block 110, the system creates an indicator that the user has exhausted one question for that particular day.

Returning to decision diamond 312 of FIG. 9, the prospective forum member is provided with an alternative if he does not like the question 312. That is, at decision diamond 320, a prospective forum member is asked whether he selected a question to vote on or respond to. If the response is in the affirmative, the system proceeds upwardly to step 350A (see step 350 of FIG. 1) and, therefrom to decision diamond 326 which asks “Did the user choose an answer to vote upon?” Therefrom the system proceeds to block 328 in which the system adds a vote, that is, a credit for the answer of the forum user has chosen to provide. Therefrom, at block 112, the system creates an indicator that the user has used up one vote for one day.

Returning to decision diamond 320, the user may, further alternatively, proceed to decision diamond 322 in which the forum member is asked if a selected flag of particular question as inappropriate. If the answer thereto is in the affirmative, the system proceeds to step 802 in which the system displays a question or answer which the user or forum member may flag as inappropriate. This is confirmed at decision diamond 330. If so, the system proceeds to step 114 in which the system adds a value of one credit to a flag counter of selected questions or answers of the user and the system evaluates whether the question exceeded the maximum number allowed. That is, a user is rewarded for recognizing an inappropriate question or answer. From step 114, the system proceeds to decision diamond 116 and asks if the flag of value is equal or greater than a given value? From decision diamond 116, the answer may be either yes or no. If yes, the system proceeds to block 118 whereby the system removes the inappropriate answer or question so that it is no longer visible to other users of the system. However, if the response to diamond 116 is negative the system simply proceeds to block 112 and therefrom to connection node L which leads to start-up screen 102.

Finally with respect to FIG. 9, if the user, proceeding upward from diamond 310 declines decision diamonds 310, 320 and 322, he may proceed to decision diamond 324 which asks if the user chose to ask a question about the original question, this corresponding to step 355 in FIG. 1. If the answer thereto is in the negative, the system returns to categoric display step 304 as above described. However, if a response to decision diamond 324 is in the affirmative, the system proceeds up to step 326 and the system then displays the question and an empty dialog box into which the user may enter his question. The system then asks, at diamond 328 whether a question was submitted. If so, at block 477, the system place an indicator to designate the existence of the original question. Therein the user is provided with the option to return to the main menu 102 or to the categoric menu 304 to look for more questions. The AI of the system may also amend a given question at this step.

With regard to FIG. 10, the same, firstly, indicates that, at node K operates as an offshoot or in communication with node K of FIG. 8. The first decision diamond in FIG. 10 is 603 in which the user is asked if he wishes to create a goal. This relates closely to the sub-routine shown to the right of FIG. 10.

Alternative to diamond 603, the user may proceed to diamond 661A (which is closely related to step 662 of FIG. 3), in which the system asks if the user wants to edit his goal.

Alternative to diamond 661A, the user may proceed to a menu of diamond 105, in which the user is asked if he wishes to review his file. Yet further alternative to decision diamonds 603, 661A and 105, the user may proceed to decision diamond 502 which is a further menu choice but one relative to the commercial function of the present system in which the user is asked to indicate if he wishes to redeem his points or credits. If he so indicates, the system proceeds to step 504 and thereat displays a list of all categories of prizes. An input from node K (from FIG. 8) to step 504 is provided. As above noted, node K is offshoot of diamond 106 as shown in FIG. 8. Proceeding to the right hand side of FIG. 10, at decision diamond 505, the user is asked if he has selected a prize category. If the answer thereto is in the affirmative, the system displays a list of prize subcategories that may be of interest to the user. The system, at diamond 507 then asks if the user picked a prize subcategory of interest. If so, the system proceeds to diamond 508 and determines if there exists a list of businesses which are applicable to the prize sub-category selected by the user at 507. If the answer thereto is in the negative, the program returns to step 506. However, if in the positive, it proceeds to diamond 510 asking “Did the user select a business on the sub-category list?” If so, the system proceeds to step 512 and displays all businesses in the sub-sub-category of interest.

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

1. A method for facilitating decision-making related to goal attainment, the steps of the method comprising:
(a) providing a pool of prospective category-specific advisors, each of which have joined a membership community;
(b) selecting from said pool of category specific advisors, a subset thereof sufficient to define an online forum qualified for consideration of a given goal-related question;
(c) syntactically refining the goal-oriented question expressed by a system user by resolving said question into components, said refining step comprising:
(i) reviewing for and providing accuracy of form of said components by a language processing agent of said system; and
(ii) reviewing for accuracy of substantive meaning by the system user of said goal oriented question components;
(d) providing said refined question components to said forum for consideration thereby; and
(e) providing from said forum to the system user respective answers or opinions of the forum in response to said goal oriented question and components thereof.

2. The method as recited in claim 1, further comprising the step of:
evaluating said forum responses by said system user.

3. The method as recited in claim 1, further comprising the step of:
awarding to forum participants credits having commercial value usable in accordance with a set of rules.

4. The method as recited in claim 1, further comprising the step of:
intercepting a forum member response if a threat-related term or phrase is monitored by a language monitoring agent of the system.

5. The method as recited in claim 3, further comprising the step of:
evaluating said forum responses by said system user.

6. The method as recited in claim 2, further comprising the step of:
awarding of credits having commercial value to each forum participants for use in accordance with a rule set.

7. The method as recited in claim 5, further comprising the step of:
awarding of credits having commercial value to each forum participants for use in accordance with a rule set.

8. The method as recited in claim 1, in which said reviewing for accuracy of Step (c) (ii) above further comprises:
assisting such reviewing by attaching to the syntax of components or subcomponents of the question conceptual indicators regarding the meaning of the question or given components thereof.

9. The method as recited in claim 1, further comprising the step of:
attaching a calendar of dates to steps in the present method.

10. The method as recited in claim 6, further comprising the steps of:
re-iterating the steps of claims 1 and 2 until the system user expresses satisfaction with the forum responses.
